(19) United States
(12) Patent Application Publication
(10) Pub. No.: US 2011/0024683 A1
(43) Pub. Date: Feb. 3, 2011

(54) METHOD FOR CONTROLLING THE SIZE OF RARE-EARTH-DOPED FLUORIDE NANOPARTICLES - II

(75) Inventor: PAUL GREGORY BEKIARIAN, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/534,284

(22) Filed: Aug. 3, 2009

(51) Int. Cl. C09K 11/61; C01B 9/08; C01F 11/22

(52) U.S. Cl. 252/301.4 H; 423/489; 423/490; 977/773

(57) ABSTRACT

For a continuous process for preparing rare-earth doped Group 2 or Group 3 metal fluoride nanoparticles comprising a confluence of feed streams of reagents, a method is provided for controlling particle size by adjustment in the flow rate of the streams.

### PRIOR APPLICATIONS

This application claims priority to application Ser. No. 11/445,528, filed on Jun. 2, 2006 which is herein incorporated by reference.

### FIELD OF THE INVENTION

The present invention provides a method for controlling the size of Group 2 or Group 3 metal fluoride nanoparticles formed in a continuous aqueous process.

### BACKGROUND OF THE INVENTION

Several references describing methods for controlling the size of fluoride nanoparticles follow. Bender et al., Chem. Mater. 2000, 12, 1969-1076, discloses a process for preparing Nd-doped BaF₂ nanoparticles by reverse microemulsion technology. Bender expressly states that aqueous salt solutions such as 0.06 M Ba⁺², produce particles smaller than 100 nm while concentrations of about 0.3 M Ba⁺² resulting in particles larger than 100 nm. Luminescing particles are disclosed. Bender discloses a decrease in lattice parameter for BaF₂ nanoparticles doped with Nd.

Wang et al., Solid State Communications 133 (2005), 775-779, discloses a process for preparing 15-20 nm Eu-doped CaF₂ particles in ethanol. Wang expressly teaches away from employing an aqueous reaction medium.

Wu et al., Mat. Res. Soc. Symp. Proc. 286, 27-32 (1993) disclose that CaF₂ particles produced by a vapor phase condensation process are characterized by an average particle size of 16 nm while Ca_{0.75}La_{0.25}F_{2.25} particles prepared by the same process were characterized by average diameter of 11 nm.

Stouwdam et al., Nano Lett. 2(7) (2002), 733-737, discloses synthesis of rare-earth-doped LaF₃ in ethanol/water solution incorporating a surfactant to control particle size. The resultant produced incorporates the surfactant. 5-10 nm particles are prepared.

Haubold et al., U.S. Patent Publication 2003/0032192, discloses a broad range of doped fluoride compositions prepared employing organic solutions at temperatures in the range of 200-250° C. 30 nm particles are disclosed. The organic solvent employed degrades and acts as a particle-size controlling surfactant.

Knowles-van Cappellen et al., Geochim. Cosmochim. Acta 61(9) 1871-1877 (1997), discloses preparation of 214±21 nm particles by combining in aqueous solution equal volumes of 0.1 M Ca(NO₃)₂ and 0.2 M of NaF. Knowles-van Cappellen is silent regarding doped particles.

The references teach methods for preparation of multi-valent fluorides, doped and undoped, with particle sizes in the range of about 2 to 500 nm. The teachings are confined to non-aqueous reaction media, or water/alcohol. The methods teach various means for controlling the particle size produced. For example, Bender teaches that higher concentrations of reactants lead to larger particles. Others show that the presence of a rare-earth dopant decreases particle size. Still others, Stouwdam, op.cit., and Haubold, op. cit., employ surfactants to control particle size.

It is desirable to have a method for controlling the size of metal fluoride nanoparticles precipitated from aqueous solution.

### SUMMARY OF THE INVENTION

A method is provided for controlling the size of nanoscale Group 2 or Group 3 metal fluoride particles prepared in a continuous process comprising the confluence of a plurality of feed streams each feed stream being characterized by a flow rate, the method comprising increasing the flow rate to reduce the average particle size, and decreasing the flow rate to increase the average particle size the continuous process further comprising mutually contacting the plurality of feed streams thereby combining the feed streams into a single discharge stream and discharging the discharge stream into a receiving vessel;
wherein, the plurality of feed streams comprises
a first feed stream comprising a first aqueous solution of a fluoride selected from the group consisting of alkali metal fluorides, ammonium fluoride, hydrogen fluoride, and mixtures thereof wherein the fluoride has a concentration in the range of 0.1 normal to 3 normal; and,
a second feed stream comprising a second aqueous solution of a Group 2 or Group 3 metal salt at a concentration in the range of 0.1 normal to 3 normal;
   thereby forming a precipitate of an aqueously insoluble Group 2 or Group 3 metal fluoride the precipitate comprising particles characterized by an average equivalent spherical diameter in the range of 2 to 200 nm characterized by an aqueous solubility of less than 0.1 g/100 g of water.

In one embodiment, the continuous process further comprises contacting said first and second feed streams with a third feed stream comprising a third aqueous solution of a rare-earth metal dopant salt wherein the absolute amount of the rare-earth metal dopant salt is in the range of 0.5 to 25 mol-% of the molar concentration of the Group 2 or Group 3 metal salt.

In a further embodiment, the second and third aqueous solutions are combined into a single feed stream before contacting with the first feed stream;

### BRIEF DESCRIPTION OF THE DRAWINGS

FIG. 1 shows a schematic representation of the two-channel continuous flow reactor that was employed in the Examples.

### DETAILED DESCRIPTION

Nanoparticles of Group 2 and Group 3 fluorides have broad utility in many fields where the small size reduces light scattering and haze. Applications include use in forming optical components, such as lenses, and windows. The doped particles exhibit luminescence and are useful for the formation of lasers, optical displays, and optical amplifiers. The present invention is directed to controlling the size of the nanoscale particles.

For the purposes of the present invention, the term “nanoparticles” shall be understood to refer to an ensemble of particles whereof the average equivalent spherical diameter (AESD) of the particles lies in the range of 2 to 200 nm. AESD is determined from dynamic light scattering. For the purposes of this invention, when the term “particle size” is employed, it shall be understood to refer to the particle size expressed as the AESD as determined from dynamic light scattering data.

For the purposes of the present invention, when a range of numerical values is provided, it shall be understood that the end points of the stated range are included therein, unless specifically stated to be otherwise.

The term “Group 2 or Group 3 metal cation” refers to a cation formed from a metal listed in the periodic table of the elements under Group 2 or Group 3, including the lanthanide series. According to the process hereof, an aqueous solution of a Group 2 or Group 3 metal salt, and an aqueous solution of a fluoride salt, and, optionally, an aqueous solution of a dopant rare-earth metal salt, are combined to form a precipitate of nanoscale particles comprising an aqueously highly insoluble Group 2 or Group 3 metal fluoride compound that is optionally rare-earth doped The term “Group 2 or Group 3 metal fluoride” refers to the fluoride salt formed between the Group 2 or Group 3 metal cation and fluoride. “Group 2 or Group 3 salt” refers to an aqueously soluble starting salt of the process hereof; the cationic moiety thereof being the Group 2 or Group 3 metal cation defined supra. The term “rare-earth” refers to the members of the Lanthanide Series in the periodic table, namely La, Ce, Pr, Nd, Pm, Sm, Eu, Gd, Tb, Dy, Ho, Er, Tm, Yb, and Lu. The term “rare-earth salt” refers to an aqueously soluble starting salt of the process hereof. The term “fluoride salt” refers to an aqueously soluble starting salt of the process hereof.

For the purposes of the present invention, the term “Group 2 or Group 3 fluoride” refers to the so-called host compound, into the crystalline lattice of which the optional dopant hereof is inserted. Some rare-earth species, such as Lanthanum, are suitable for use both as the host and as the dopant. Other rare-earth species are suitable for use only as dopants.

According to the present invention, an aqueous solution of a Group 2 or Group 3 metal salt, and an aqueous solution of fluoride salt, and, optionally, an aqueous solution of a dopant rare-earth salt, are combined to form a highly insoluble, optionally rare-earth-doped, Group 2 or Group 3 metal fluoride. The reaction in aqueous solution of the soluble fluoride with the soluble Group 2 or Group 3 metal cation is virtually instantaneous. The low solubility of the Group 2 or Group 3 metal fluoride hereby prepared which can be but need not be rare-earth-doped, ensures that precipitation occurs so quickly in the process of the invention that there is little time for crystal growth before precipitation. The Group 2 or Group 3 metal fluorides produced by the method hereof are characterized by an aqueous solubility of less than 0.1 g/100 g of water and a particle size characterized by an AESD in the range of 2 to 200 nm.

The present invention discloses a novel method for controlling the particle size of Group 2 or Group 3 metal fluoride that is optionally rare-earth-doped nanoparticles in the size range of 2 to 200 nm in AESD, that are prepared in a completely aqueous continuous process comprising the confluence of a plurality of feed streams each feed stream being characterized by a flow rate, the method comprising increasing the flow rate to reduce the average particle size, and decreasing the flow rate to increase the average particle size

The term “feed solution” refers to the aqueous solutions prepared respectively from the Group 2 or Group 3 metal salt, the optional dopant rare-earth salt, and the fluoride salt. In one embodiment, no dopant rare-earth salt is present. In an alternative embodiment, a third feed stream comprises an aqueous solution of a rare-earth dopant salt, In another alternative embodiment, the Group 2 or Group 3 metal salt and rare-earth salt may be combined into a single feed stream before contacting with the aqueously soluble fluoride feed stream.

Accordingly, a first feed stream comprising a first aqueous solution of a fluoride selected from the group consisting of alkali metal fluorides, ammonium fluoride, hydrogen fluoride, and mixtures thereof at a concentration in the range of 0.1 normal to 3 normal is contacted with a second feed stream comprising a second aqueous solution of a Group 2 or Group 3 metal salt at a concentration in the range of 0.1 to 3 normal, and, optionally, a third stream comprising a third aqueous solution of a rare-earth dopant salt at a concentration such that the molar ratio of rare-earth dopant salt concentration to Group 2 or Group 3 metal salt concentration lies in the range of 0.005 to 0.25 (0.5 to 25 mol-%). Optionally, the second and third aqueous solutions can be combined into a single feed stream prior to contacting with the first feed stream. The particles thereby formed are Group 2 or Group 3 metal fluoride that is optionally rare-earth-doped are characterized by a particle size in the range of 2 to 200 nm.

The actual value of AESD which will be realized for any given concentration of starting ingredients depends upon numerous specific reaction ingredients and conditions. Factors which affect the value of AESD at a fixed concentration level include but are not limited to: the chemical identity of the reactants, the presence and concentration of dopant, the solubility of the Group 2 or Group 3 metal fluoride, the flow rates of the feed streams in a continuous process, and the method of product separation.

The first reaction or two for a given set of reactants and reaction conditions will allow the practitioner hereof to determine the range of AESD provided by the initially selected concentrations. Coarse tuning the value of AESD can be accomplished by altering the concentration of one or more starting materials. In the process hereof, it is preferred to combine the fluoride and the Group 2 or Group 3 metal and dopant cations in stoichiometric concentration. However, exact stoichiometric conditions are not required. In one embodiment, coarse tuning of AESD is achieved by altering the concentrations of all the reactants in such manner as to retain stoichiometric proportions.

In one embodiment, adjustment of the value of AESD is accomplished by making changes in the concentration of the dopant rare-earth salt in the feed solution. In one embodiment, the overall cationic concentration is held constant but the molar ratio of dopant rare-earth cation concentration to the Group 2 or Group 3 metal salt concentration is altered. Final adjustment of particle size is then accomplished by adjusting the feed rate, as shown in the examples, infra.

Any Group 2 or Group 3 metal salt can be employed in the process with the proviso that the corresponding Group 2 or Group 3 metal fluoride produced hereby is characterized by an aqueous solubility of less than 0.1 g/100 g at room temperature. Aqueous solubilities of inorganic fluorides are available from a number of sources, including the well-known CRC Handbook of Chemistry and Physics, 8^{th} Edition. Fluorides which as are listed as having solubility below 0.1 g/100 g water or indicated to be “insoluble” in water are suitable for employment in the method of the invention. Many rare-earth fluorides are soluble in water, and are therefore not suitable for use as the Group 2 or Group 3 metal cation, although all the rare-earth metal cations are suitable for use as dopants.

Group 2 or Group 3 metal cations suitable for use in the present invention include Ca⁺², Mg⁺², Sr⁺², Y⁺³, La⁺³, Ac⁺³, Cr⁺³, Mo⁺³, Ir⁺³, Cu⁺², Ga⁺³ and Pb⁺², as well as the rare-earths Ce⁺³, Nd⁺³, Eu⁺³, Er⁺³, Yb⁺³, and Lu⁺³. Rare-earths are frequently employed as dopants in the art, and the numerous Group 2 or Group 3 metal fluorides prepared according to the process hereof may be subject to doping by incorporating a soluble rare-earth salt into the reaction mixture. However, the rare-earths recited above are not dopants but serve as alternative Group 2 or Group 3 metal cations, subject to the limitations of the process, namely that the resulting rare-earth fluoride salt must have a solubility less than 0.1 g/100 ml of water. While all rare-earths are suitable to use as dopants, only those recited above are suitable to use as the Group 2 or Group 3 metal cations in the method of the present invention.

Preferred anions for the soluble Group 2 or Group 3 metal salt are chloride, nitrate, sulphate, acetate, hydroxide, phosphate, carbonate, and bromide. Preferably the aqueously soluble fluoride is NaF, KF, or NH₄F, most preferably NH₄F. Preferably, the Group 2 or Group 3 metal cation is Ca⁺² in the form of CaCl₂, Ca(NO₃)₂, or CaSO₄. In one embodiment, the concentration of Ca⁺² is in the range of 0.76 to 1.6 normal, and the concentration of fluoride is 0.76 to 1.6 normal. Preferably the reactants are combined in stoichiometric quantities.

It is observed in the practice of the invention, that use of an alkali metal fluoride in combination with certain Group 2 or Group 3 metal cations may result in a mixture of fluorides. This problem can be remedied by employing NH₄⁺ in place of an alkali metal in the process. For that reason NH₄F is a preferred starting material if there is any question about undesirably contaminating the pure Group 2 or Group 3 metal fluoride with the alkali-containing contaminant.

The soluble salt starting materials need only be soluble enough to form aqueous solutions of the desired concentrations for the purposes of the present invention. From the standpoint of the present invention, a salt is said to be aqueously soluble if a solution of the desired concentration can be formed from it.

In one embodiment, the first and second, and, optionally third, feed streams are fed continuously and simultaneously to a mixing chamber where the streams directly impinge on each other to combine and mix while being ultrasonically agitated at constant temperature followed by discharge of the so-formed nano-particle suspension to a product receiving vessel.

Residual soluble inorganic salts are removed from the thus formed nano-particle suspension by any means conventionally employed in the art for separating soluble salts from a fine particle suspension. In a preferred embodiment, the separation is effected by dialysis.” It is preferred that the nanoparticles prepared in the process of the invention be subject to water washing in order to remove any residual water soluble starting materials. Dispersing in water followed by centrifugation is one effective method. Dialysis or ion exchange are useful alternatives to centrifugation. Dialysis is highly effective at keeping the particles dispersed while removing residual soluble salts. By avoiding the compaction associated with centrifugation, the smallest possible particle size is maintained.

Suitable dialysis membrane tubing known to the art include but are not limited to those made from regenerated cellulose or cellulose esters that are commercially available under brand names such as Spectra Por™ Molecular Porous Membrane Tubing sold by Spectrum Laboratories. Suitable are membranes having a molecular weight cut-off (MWCO) of 1,000-50,000 Da are suitable for the removal of soluble salts from the nano-particle suspensions prepared in the process of the invention. A MWCO of 10,000-20,000 Da is preferred.

In one embodiment, the nano-particle suspensions are sealed within the dialysis membrane tubing and immersed in a reservoir of deionized water to allow the soluble salts to pass from the nano-particle suspension through the membrane and into the reservoir while the nano-particles are confined to the interior of the dialysis membrane tubing where they remain suspended without compaction. The water in the reservoir is replaced with fresh deionized water either continuously or at intervals to facilitate removal of the soluble salts from the nano-particle suspension prepared in the process of the invention. The dialysis can be conducted at any temperature within the tolerances of the dialysis membrane tubing but it is preferred to conduct the dialysis at ambient temperature. The dialysis process can be deemed complete at the discretion of the practitioner. It is preferred that the dialysis be continued until the ionic conductivity of the nano-particle suspension within the dialysis membrane tubing has decreased to a constant value.

For dispersion in non-polar solvents, it may be required to combine the particles produced by the process with surfactants, as taught in the art.

Other suitable methods of separating the precipitate from aqueous salt by-products include ion exchange, and electrodialysis. Methods for concentrating or drying the precipitated fluoride include evaporation of water, centrifugation, ultrafiltration, and electrodecantation. In one embodiment, ion exchange resins remove soluble salt residues followed by evaporation to concentrate the colloidal sol produced in the process.

One goal of a production process is product uniformity. It is understood that in real world production processes some fluctuations will occur, and the effect of these fluctuations determines the product release tolerances. Thus any method that permits tighter tolerances is highly desirable.

In the present invention, the method provides for the preparation of a plurality of test specimens aimed at defining the dependence of particle size on flow rate in order to identify the flow rate settings corresponding to the desired particle size. The test specimens are prepared according to the process outlined supra and in accordance with the Examples presented infra.

As shown in the Examples of the continuous process hereof, infra, for any given set of ingredients and conditions, wherein the feed streams are set at a flow rate, particle size of the Group 2 or Group 3 metal fluoride precipitate that is optionally rare-earth doped can be increased by decreasing the flow rate while particle size can be decreased by increasing the flow rate. It is not necessary for the practice of the invention that the flow rates of the two feed streams be equal, but it is preferred.

The practice of the invention is further described in but not limited to the following specific embodiments.

### EXAMPLES

### Examples 2-5 and Comparative Example B

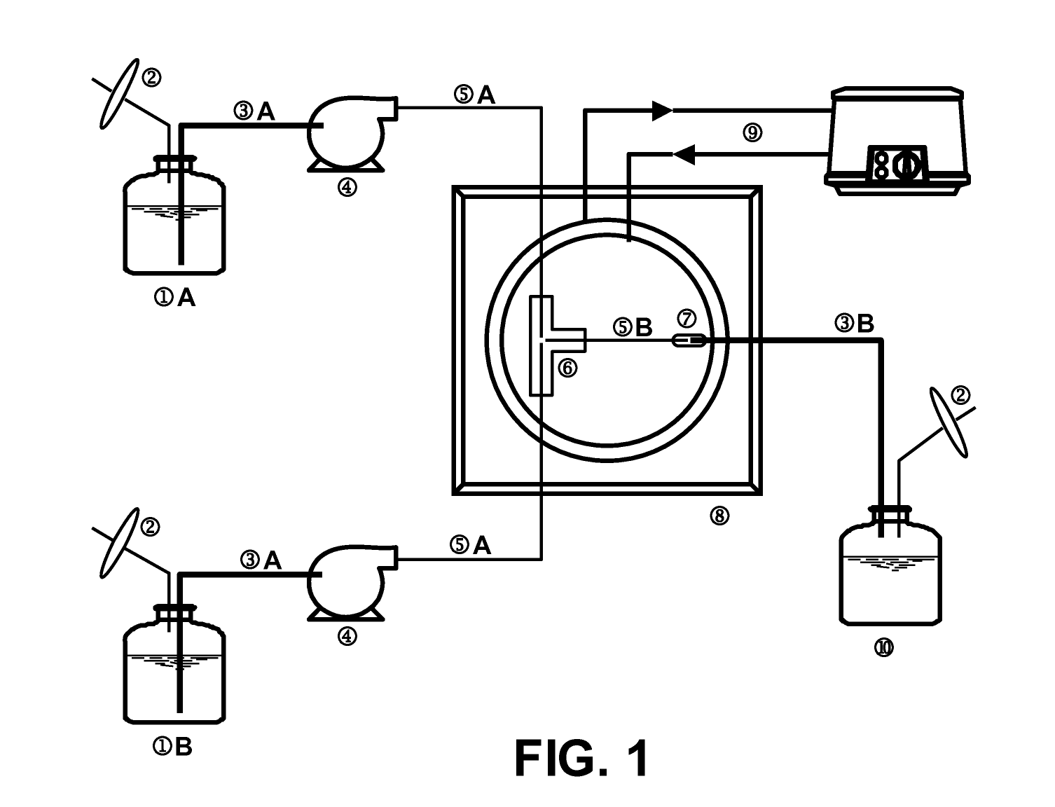

In the following examples a continuous two feed flow system was employed. FIG. 1 depicts the system. A dual channel Masterflex™ peristaltic pump [4] was equipped with #16 C-Flex™ tubing. Polyethylene tubing (¼ inch OD, ⅛ inch ID) [3A] was attached to the C-Flex tubing on the back side (feed side) of the pump as the main line tubing that would transport the Ca(NO₃)₂ or combined Ca(NO₃)₂ and rare-earth nitrate solution first feed stream, and ammonium fluoride solution second feed stream from reservoirs 1A and 1B respectively. Polyethylene tubing (⅛ inch OD, 1/16 inch ID) [5A] was attached to the C-Flex tubing on the front side (effluent side) of the pump as the main line feed tubing that would transport the feed stream solutions to the 1/16^{th} inch ID plastic T-mixer [6]. The feed streams were directed respectively into opposite ends of the T so that they would intersect each other at an angle of 180 degrees. The product output of the T-mixer was directed out at 90° from the feed streams and carried through approximately 4 inches of polyethylene tubing (⅛ inch OD, 1/16 inch ID) [5B] into a polyethylene union (⅛ inch to ¼ inch) [7] then through polyethylene tubing (¼ inch OD, ⅛ inch ID) [3B] into a clean product receiving bottle [10]. The product receiving bottle was equipped with 0.2μ membrane gas filters [2] on the vent to keep out extraneous dust. The reactor assembly, comprising approximately 3 inches of feed tubing [5A], the T-mixer [6], the 4 inches of effluent tubing [5B] and the ⅛ inch to ¼ inch union [7], was immersed in the cavity of a VWR™ Model 250D Ultrasonic bath [8]. A copper cooling coil (⅜ inch OD, 44 inch length) attached to a Neslab™ Model RTE-7 chiller [9] was suspended in the ultrasonic bath to maintain temperature.

### General Experimental Procedures

### Preparation of Reagents

The calcium, lanthanum, and europium nitrates were purchased as the hydrates from the Aldrich Chemical Company. Anhydrous ammonium fluoride was also purchased from the Aldrich Chemical Company. The as-received reagents were put under static vacuum (<1 torr) on a vacuum line for 20 hr at ambient temperature to remove adsorbed water. All aqueous solutions were prepared using 18.0

MOhm deionized water obtained from a Barnstead NanoPure™ model D4741 water purifier and filtered 0.2μ at the point of delivery The Ca(NO₃)₂ and any rare-earth nitrate were combined in a single solution before feeding into the reaction system. Each soluble salt solution of a given concentration was prepared by combining the quantities of Ca(NO₃)₂ and any rare-earth nitrate as specified in Table 1, with deionized water in a 1000 ml volumetric flask to dissolve the solids and then diluting to a total solution volume of 1000 ml.

Each soluble fluoride solution of a given concentration was prepared by combining the quantity of NH₄F as specified in Table 2, with deionized water in a 1000 ml volumetric flask to dissolve the solids and then diluting to a total solution volume of 1000 ml.

Referring to FIG. 1, the so-prepared solutions were then filtered through 0.22μ cellulose acetate membranes into separate polycarbonate reservoirs [1] and capped. The feed solution reservoir caps were equipped with 0.2μ membrane gas filters [2] on the vents to keep out extraneous dust. In Table 1, the term “rare earth mole %” refers to the mole fraction of rare earth salt vs. the combined Ca⁺² salt plus rare earth salt.

TABLE 1

| | rare | Ca(NO₃)₂•4H₂O | | La(NO₃)₃•6H₂O | | Eu(NO₃)₃•6H₂O | | for |
|---|---|---|---|---|---|---|---|---|
| solution | earth mole % | molarity | grams | molarity | grams | molarity | grams | example |
| S-1 | 0 | 0.2 | 47.2 | | | | | 1 |
| S-2 | 0 | 0.4 | 94.46 | | | | | 2 |
| S-3 | 0 | 0.8 | 188.92 | | | | | 3 |
| S-4 | 0 | 1.2 | 283.38 | | | | | 4 |
| S-5 | 5.0 | 0.38 | 89.74 | 0.02 | 8.66 | | | 6 |
| S-6 | 4.76 | 0.4 | 94.46 | 0.02 | 8.66 | | | 7, 8 |
| S-7 | 5.0 | 0.38 | 89.74 | | | 0.02 | 8.92 | 5 |

TABLE 2

| | |
|---|---|
| NH₄F | for |

| solution | molarity | grams | example |
|---|---|---|---|
| S-8 | 0.4 | 14.8 | 1 |
| S-9 | 0.8 | 29.64 | 2, 7 |
| S-10 | 0.82 | 30.4 | 5, 6 |
| S-11 | 0.92 | 34.08 | 8 |
| S-12 | 1.6 | 59.26 | 3 |
| S-13 | 2.4 | 88.90 | 4 |

### Product Preparation

Prior to starting the reaction the pumping system was first primed and purged by flushing filtered deionized water through the lines. The back-side feed lines were then immersed in the respective feed solutions in their respective reservoirs. The ultrasonic cleaning bath and Neslab chiller were turned on, and the chiller adjusted to give the desired temperature of 20°-25° C. in the ultrasonic bath. Simultaneous pumping of the feed solutions was started at the desired flow rate and maintained to flush the lines with reactant solutions and start production. The initial 50 ml of CaF₂ (doped or undoped) nanoparticle slurry product was directed to a waste container. Without interrupting the pumping, the product output line was switched to a product collection bottle and the reaction was run until approximately 100-120 ml of the doped or undoped CaF₂ nano-particle suspension was accumulated.

The cloudy as-made suspension was purified to remove soluble ammonium nitrate salts by dialysis. After dialysis, the purified metal fluoride nano-particle suspension was ultrasonically agitated for 5 min using a 0.25 inch diameter microprobe attached to a Branson™ Digital Sonifier (model 450). During ultrasonic agitation, the vessel containing the product doped or undoped CaF₂ nano-particle suspension was cooled in a water-ice bath. After ultrasonic agitation, a sample of the purified product was diluted with deionized water to contain 0.25-1.0 wt % of the nano-particles and the effective diameter of the nano-particles was measured by light scattering.

### Dialysis Purification of Product

Tubular dialysis membranes (Spectra Por™ Molecular Porous Membrane Tubing, 29 mm diameter, 45 mm flat width, MWCO=12-14,000 da, capacity=6.4 ml/cm of length) sold by Spectrum Laboratories were used to purify the doped or undoped CaF₂ suspension.

A 22 cm long strip of dialysis tubing was immersed and soaked in deionized water to soften the tubing. One end of the tubing was sealed with a plastic clamp and 100 ml of nano-particle suspension was poured into the other end which was then likewise sealed. The filled dialysis tube was then suspended vertically and fully immersed in a water bath comprised of a 5 liter plastic beaker that was filled with deionized water with stirring by a magnetic stirring bar. Several (1-6) such tubes could be simultaneously so immersed in the same water bath. The bath water was exchanged with fresh deionized water approximately every two hours on the first day of the dialysis process. On subsequent days of the dialysis process, the bath water was exchanged with fresh deionized water three times during an 8 hr period, in the morning, at noon, and in the evening. The dialysis process was continued thus for several days. On the fourth day of the dialysis process and each day afterward, the conductivity of the nano-particle suspension within the dialysis tubing was measured using the method described infra, and noted. The dialysis process was continued until the conductivity of the nano-particle suspension within the dialysis tubing stopped decreasing and reached a steady state. At this point the process was deemed complete and the purified nano-particle suspension was transferred from the dialysis tubing into a glass container and sealed for storage.

### Conductivity Measurement

The conductivity of the aqueous nano-particle suspensions was measured using a VWR™ model 4063 conductivity meter equipped with a model 4061 epoxy probe. The conductivity meter was calibrated, in accord with it's written instructions, at three points with solutions of known conductivity. The three solutions of known conductivity were VWR™ brand Traceable Conductivity Standards at values, 1.75 μS/cm (catalog number 36934-134), 8.94 μS/cm (catalog number 23226-567), and 98.5 pS/cm (catalog number 23226-589).

To measure conductivity, the probe was first rinsed with deionized water (18.0 MOhm deionized water from a Barnstead NanoPure™ model D4741 water purifier, filtered 0.2μ at delivery) then blown dry with a stream of nitrogen. The probe was then immersed in the target liquid and moved around to stir the liquid. The conductivity of the liquid was read from the digital display of the conductivity meter.

### Particle Size Analysis

For particle size analysis, an aliquot of the suspension was diluted in water to 0.25-1.0 wt-% solids content. Particle size was then measured using a Brookhaven Instruments BI200SM goniometer set at 90 degrees scattering angle. The incident light was a 50 mW Melles Griot He—Ne laser (632.8 nm wavelength). The pinhole was typically set to 400 microns. An interference filter with a narrow bandpass at 632.8 nm was used to eliminate any extraneous light. Photon counts were acquired using a Brookhaven Instruments BI-APD avalanche photodiode. The auto-correlation function was acquired with a Brookhaven Instruments B12030 auto-correlator. The analysis software used was the Particle Sizing software from Brookhaven Instruments.

To measure particle size, the sample holder was rinsed with filtered deionized water and blown dry with a stream of filtered nitrogen. The nano-particle suspension was charged to the sample holder, placed in the instrument chamber and allowed to thermally equilibrate (25° C.). For each sample, five analysis runs of five minutes each were acquired. The cumulative correlation function was fit with the method of cumulants to obtain the z-average diffusion coefficient and normalized second cumulant (polydispersity term). The z-average diffusion coefficient was converted to an average equivalent spherical diameter of the nano-particles using the Stokes-Einstein expression and where the viscosity of water is assigned as 0.955 cP.

### Examples 1-5

In the following examples, calcium fluoride nano-particle suspensions were prepared using the materials and the method of the General Experimental Procedure described supra. A series of reactions were run in which reagent concentration remained constant at different values, and the feed stream flow rate was varied, as shown in Table 3. The concentration of the reagent solutions, the reaction flow rates and the effective diameter of the nano-particles are tabulated in Table 1.

TABLE 3

| | | | Feed Stream | |
|---|---|---|---|---|
| | Ca(NO₃)₂ | NH₄F | Flow Rate | AESD |
| Specimen | (M) | (M) | (ml/min) | (nm) |
| 1-1 | 0.2 | 0.4 | 10 | 208.4 nm |
| 1-2 | 0.2 | 0.4 | 40 | 141.5 nm |
| 1-3 | 0.2 | 0.4 | 80 | 129.3 nm |
| 2-1 | 0.4 | 0.8 | 10 | 163.7 nm |
| 2-2 | 0.4 | 0.8 | 40 | 126.4 nm |
| 2-3 | 0.4 | 0.8 | 80 | 121.7 nm |
| 3-1 | 0.8 | 1.6 | 10 | 135.4 nm |
| 3-2 | 0.8 | 1.6 | 40 | 91.4 nm |
| 3-3 | 0.8 | 1.6 | 80 | 89.7 nm |
| 4-1 | 1.2 | 2.4 | 10 | 115.4 nm |
| 4-2 | 1.2 | 2.4 | 40 | 86.5 nm |
| 4-3 | 1.2 | 2.4 | 80 | 84.5 nm |

These examples demonstrate the decrease in particle size of the metal fluoride nano-particles with increasing flow rate at a given concentration of reagents.

### Examples 5-8

In the following examples, rare-earth doped CaF₂ was prepared according to the process herein described. Both Eu and La were employed as dopants as indicated in Table 4. For each concentration of reagents, a series of three specimens were prepared at different feed stream flow rates, as indicated in Table 4. Table 2 shows the particle size results.

TABLE 4

| | | Concentrations | | | | |
|---|---|---|---|---|---|---|
| | | | Rare | | Feed | |
| | Rare- | Ca(NO₃)₂ | Earth | NH₄ | flow | AESD |
| Specimen | Earth | (M) | (M) | (M) | rate | (nm) |
| 5-1 | Eu | 0.4 | 0.02 | 0.82 | 10 | 54.7 |
| 5-2 | Eu | 0.4 | 0.02 | 0.82 | 40 | 45.5 |
| 5-3 | Eu | 0.4 | 0.02 | 0.82 | 80 | 43.9 |
| 6-1 | La | 0.38 | 0.02 | 0.82 | 10 | 60.5 |
| 6-2 | La | 0.38 | 0.02 | 0.82 | 40 | 51.5 |
| 6-3 | La | 0.38 | 0.02 | 0.82 | 80 | 32.7 |
| 7-1 | La | 0.04 | 0.02 | 0.8 | 10 | 40.0 |
| 7-2 | La | 0.04 | 0.02 | 0.8 | 40 | 32.5 |
| 7-3 | La | 0.04 | 0.02 | 0.8 | 80 | 32.0 |
| 8-1 | La | 0.4 | 0.02 | 0.92 | 10 | 64.5 |
| 8-2 | La | 0.4 | 0.02 | 0.92 | 40 | 47.8 |
| 8-3 | La | 0.4 | 0.02 | 0.92 | 80 | 39.2 |

What is claimed is:

1. A method is provided for controlling the size of nanoscale Group 2 or Group 3 metal fluoride particles prepared in a continuous process comprising the confluence of a plurality of feed streams each feed stream being characterized by a flow rate, the method comprising increasing the flow rate to reduce the average particle size, and decreasing the flow rate to increase the average particle size;
the continuous process further comprising mutually contacting the plurality of feed streams thereby combining the feed streams into a single discharge stream and discharging the discharge stream into a product collection vessel;
wherein, the plurality of feed streams comprises
a first feed stream comprising a first aqueous solution comprising a fluoride selected from the group consisting of alkali metal fluorides, ammonium fluoride, hydrogen fluoride, and mixtures thereof wherein the fluoride has a concentration in the range of 0.1 normal to 3 normal; and,
a second feed stream comprising a second aqueous solution comprising a Group 2 or Group 3 metal salt at a concentration in the range of 0.1 normal to 3 normal;
thereby forming a precipitate of an aqueously insoluble Group 2 or Group 3 metal fluoride characterized by average equivalent spherical diameter in the range of 2 to 200 nm, and characterized by an aqueous solubility of less than 0.1 g/100 g of water.

2. The method of claim 1 further comprising a third feed stream comprising a third aqueous solution comprising a rare-earth metal dopant salt wherein the absolute amount of the rare-earth metal dopant salt is in the range of 0.5 to 25 mol-% of the molar concentration of the Group 2 or Group 3 metal salt.

3. The method of claim 2 wherein the second and third aqueous solutions are combined into a single feed stream before contacting with the first feed stream.

4. The method of claim 1, claim 2 or claim 3 wherein the Group 2 or Group 3 metal salt comprises a cation from the group consisting of Ca⁺², Mg⁺², Sr⁺², Y⁺³, La⁺³, Ac⁺³, Cr⁺³, Mo⁺³, Ir⁺³, Cu⁺², Ga⁺³, Pb⁺², Ce⁺³, Nd⁺³, Eu⁺³, Er⁺³, Yb⁺³, and Lu⁺³.

5. The method of claim 4 wherein the Group 2 or Group 3 metal cation is selected from the group consisting of Ca⁺² or La⁺³.

6. The method of claim 1 wherein the aqueous solution of a fluoride is an aqueous ammonium fluoride solution.

7. The method of claim 1, claim 2 or claim 3 further comprising purification of the precipitate by membrane dialysis.

8. The method of claim 1 wherein the normality of the aqueous fluoride and Group 2 or Group 3 metal salt solutions are equal.

9. The method of claim 1 wherein the fluoride and Group 2 or Group 3 metal salt are combined in stoichiometric amounts.

10. The method of claim 2 or claim 3 wherein the fluoride and the Group 2 or Group 3 metal salt and rare-earth metal salt are combined in stoichiometric amounts.

11. The method of claim 1, claim 2 or claim 3 wherein the flow rates of the feed streams are equal.
